(19) United States
(12) Patent Application Publication
(10) Pub. No.: US 2005/0170865 A1
(43) Pub. Date: Aug. 4, 2005

(54) Tune cutting feature

(75) Inventors: Jeanet Harvej, Copenhagen S (DK); Christian Kraft, Hvidovre (DK)

Correspondence Address: HARRINGTON & SMITH, LLP, 4 RESEARCH DRIVE, SHELTON, CT, 06484-6212, US

(73) Assignee: Nokia Corporation

(21) Appl. No.: 10/769,378

(22) Filed: Jan. 30, 2004

(51) Int. Cl. H04M 1/00; H04B 1/38

(52) U.S. Cl. 455/567; 455/414.1

(57) ABSTRACT

A mobile terminal adapted to attract the attention of a person. The terminal receives audio information and, using the mobile terminal, the user is able to select part of the audio information which the terminal then uses when the attention of the user is desired/required. The terminal may be a mobile telephone where ringing tones may be defined from audio tracks using the telephone.

The present invention relates to a tune cutting feature especially for mobile terminals, such as mobile telephones, where the tune is used for attracting the attention of a user of the terminal.

In mobile terminals, such as mobile telephones, personality is often desired by the user by personalizing the expression of the telephone. Part of the expression of a mobile terminal is the sounds which this terminal provides for attracting the attention of the user.

Such sounds may be used for informing the user that a telephone call is incoming, that a SMS/MMS has been received, that the user should wake up, that a predetermined period of time has elapsed, that a predetermined point in time is approaching, or the like. Different sounds may be desired for each of these “alarms”.

Hitherto, the user has been able to download into the terminal predetermined or pre-selected audio bits or sounds which may then be used by the terminal.

However, in order to be able to further distinguish from other terminals, the user desires to be able to, himself, precisely determine which sounds are to be used.

It is possible to generate such sounds, such as parts of music or the like, in e.g. complicated audio manipulation equipment in PC's and download the resulting tune into the telephone. However, it is desired to provide a simpler manner of determining which part of an audio track or audio information is to be used.

In a first aspect, the invention relates to a method of attracting the attention of a user of a mobile terminal, the method comprising:
the mobile terminal receiving audio information,
providing the audio information to the user,
the user operating, during the providing step, selecting means of the mobile terminal so as to select part of the audio information,
the mobile terminal subsequently attracting the attention of the user by playing the selected part of the audio information.

In the present context, “audio information” may be any information having an audio content. Also, normally, audio is compressed or encoded, but this does not alter the fact that the signal or information has audio contents. Video signals also have audio contents. Audio may be transferred as an analogue or digital signal and via a wireless or a wired connection.

The audio information may be provided/received e.g. as streaming information or in a bulk/compressed manner where it is not directly on a form where it may be provided/played.

Audio information may be any type of information which may be played, such as music, speech, exclamations, song, sounds, sound tracks or the like.

Providing the audio information to the user normally entails playing the audio to the user. However, it may also be possible to illustrate, on a display, contents of the audio signal (such as intensity or frequency contents) in order for the user to perform the present method in a noiseless or silent fashion.

Attracting the attention of the user may be obtained by playing the audio information out loud, such as when the user is not directly at the terminal or by playing it at a lower volume, such as when the user is close by or even has her/his ear nearby. This might be the situation when the user listens to other audio information provided by the terminal, where this other audio may then be interrupted by the selected audio.

The selection by the user of the selected audio information is performed while the audio information is provided to the user. This is in order to time the selection of the user in relation to the audio information provided. In this manner, the selection of the user may be correlated with individual parts of the audio information received.

In one embodiment, the providing step is performed by a signal source transmitting the audio information to the mobile terminal. Thus, the source itself may both transmit and provide the information. The determination of the timing relationship between the selection of the user and the information received is easiest if the timing relationship between the audio information provided and that received is known. Preferably, the receiving of the audio signal is simultaneous to the providing thereof so that a selection at a point in time at the terminal is a selection of a part of the audio signal provided at the same time.

The selection of the user will be e.g. a starting point in time and an ending point in time. However, these points in time should be correlated to the audio signal in order to derive the selected part thereof. If the audio signal provided to the user is provided and simultaneously received by the terminal, the selection of the user is directly correlated to the audio information, whereby the selection is easy. If a time difference exists between e.g. the receipt and the providing of the user, this dime difference is desired in order to derive the correct, selected part of the audio information.

In another embodiment, the providing step is provided by the terminal itself. In this manner, the timing relationship is much easier to handle in that no transfer/receipt/handling of the audio signal is required, whereby the terminal may directly correlate the selection by the user to the audio information (such as the points in time of starting and ending to the audio information provided in order to determine the exact selected part.

Preferably, the selecting step comprises storing the selected part of the audio information in the mobile terminal. This storage may be in made in any suitable storage media, such as RAM, EPROM, EEPROM, hard disc or the like, and the audio information may be on any form, such as analogue, digital, using compression, encoding, or any other scheme or standard.

In fact, the recording may start, when the part to be selected is about to be provided to the user, and the recording may be ended when the desired part has been provided. This is particularly suitable when no time delay is between the audio provided and that received. Naturally, the selecting step may comprise discarding non-selected parts of the audio information.

The controlling of an operation may be performed in a number of manners, such as by voice controls or simple manipulation of push buttons or the like. In a preferred embodiment, the selecting step comprises the user pushing a push button on the mobile terminal. In that manner, two consecutive operations of the push button (or other selecting means) may mark the start and ending of the selected audio information, respectively. Alternatively, all audio provided/received during a prolonged operation of the push button may be selected.

Alternatively, a representation of the audio information (such as intensity or frequency information as a function of time) may be provided on a monitor or display and the selection may be made on the basis of that graph/image, such as using a cursor or the like.

Naturally, the information may be transferred/received in any suitable manner, such as via wireless (e.g. via electromagnetic radiation such as radio waves, IR, or visible light), or via wired communication.

The audio information may be on any suitable form, such as analogue, digital, MIDI, MP3, WAV, and/or TrueTones encoded/compressed audio.

In a preferred embodiment, the attracting step comprises the mobile terminal determining that the attention of the user is desired/required before playing the selected part. This determination may be made on the basis of other processes handled by the terminal, such as when an incoming telephone call or SMS/MMS is detected in a mobile telephone, when a predetermined period of time has elapsed or when a predetermined point in time is approaching.

In the most preferred embodiment, the mobile terminal is a mobile telephone, and the attracting step comprises the mobile telephone receiving an incoming telephone call/SMS/MMS.

Naturally, any convenient or necessary conversion or other handling of the audio information may be performed, such as the conversion of the audio information between two compression/encoding schemes or the like.

In another aspect, the invention relates to a mobile terminal comprising:
means for receiving audio information,
means for allowing the user to select part of the audio information, while the receiving means receive the information,
means for attracting the attention of the user by playing the selected part of the audio information, and
means for determining that the attention of the user is desired/required, the determining means being adapted to operate the attracting means.

When a timing relation between the information provided and the timing relation received is known, it is easier to determine the selected part in that the user will normally select the part on the basis of the information provided. This may be difficult when the providing of the information is not controlled by the terminal.

Preferably, the terminal further comprises means for providing the information to the user while receiving the information. In this situation, the timing relation is more easily determined in that both processes are now controlled by the terminal.

According to a third aspect, the invention relates to a mobile terminal adapted to facilitate communication between a user and one or more external terminals, the terminal comprising:
means for receiving audio information,
means for providing the audio information to the user,
means operable by the user for selecting part of the audio information, while the information is provided to the user,
means for attracting the attention of the user by playing the selected part of the audio information, and
means for determining that the attention of the user is desired/required, the determining means being adapted to operate the attracting means.

Thus, the terminal may comprise means for storing the audio information and provide the information at a later stage in order for the user to select the part.

The below embodiments and situations relate to both the second and third aspects:

The terminal may be a mobile telephone and/or PDA. Also, the terminal may be adapted to facilitate communication between a user and one or more external terminals, such as a PC, audio equipment and/or a telephone network.

Normally, the attracting means will comprise a loudspeaker for providing the audio signal as sound in order to attract the attention of the user. The desired volume of the sound will depend on a number of factors, such as the reason for attracting the attention of the user as well as the type of terminal. Naturally, this speaker may be used for other purposes also.

The selecting means may comprise a push button, a depression of which defines a starting point of the selected part of the audio information. Another depression thereof may define an ending point in time, or the selecting means may be adapted to select a part of the audio information provided or received while the button is depressed.

The selecting means may be adapted to discard remaining part(s) of the audio information.

The selecting means may be adapted to store the selected audio information. For this purpose, the selecting means may comprise a storing means comprising a: RAM, EPROM, EEPROM, hard disc, optical disc, or the like.

Information may be provided to the storing means after a depression or other operation of the push button or other controlling means used by the user for instructing the terminal that the part to be selected is about to start.

Wherein the receiving means are adapted to receive the audio information via wireless (electromagnetic radiation (radio waves, IR, visible light)) or wired communication.

The receiving means may be adapted to receive audio information encoded/compressed in any manner, such as under the MIDI, MP3, WAV, or TrueTones schemes.

The mobile terminal preferably is a mobile telephone where the determining means are adapted to operate the attracting means when receiving an incoming telephone call/SMS/MMS.

Converting means may be provided in order to convert the audio information from one form/compression/standard/scheme to another. This may be in order to be able to e.g. handle the audio information in the terminal or in order for the information to take up less memory.

Another reason for converting the information is that audio may be provided in a packet-based manner where bits of the audio information are present in each packet. If the desired starting point or ending point is inside such a bit, it may not be possible to actually start or end the audio at those points in time. Then, it may be desired to either re-pack the information or bring it to a form where the desired points in time may be obtained.

In the following, the preferred embodiment will be described with reference to the drawings in which:

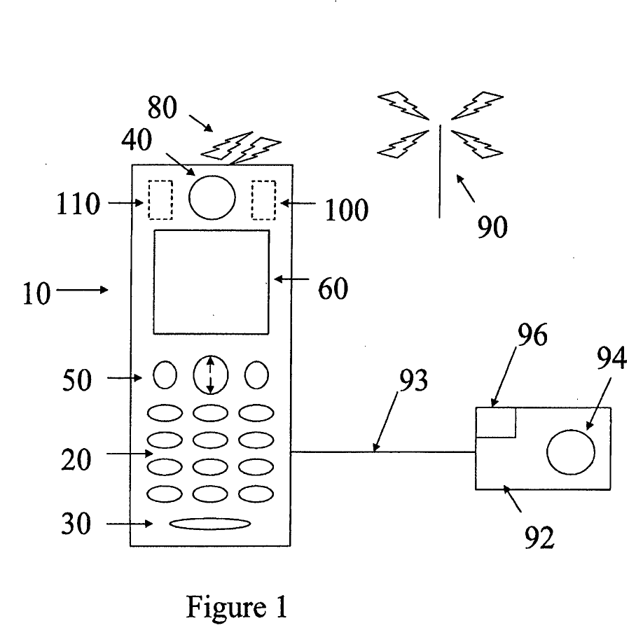

FIG. 1 illustrates a mobile telephone communicating with external sources and

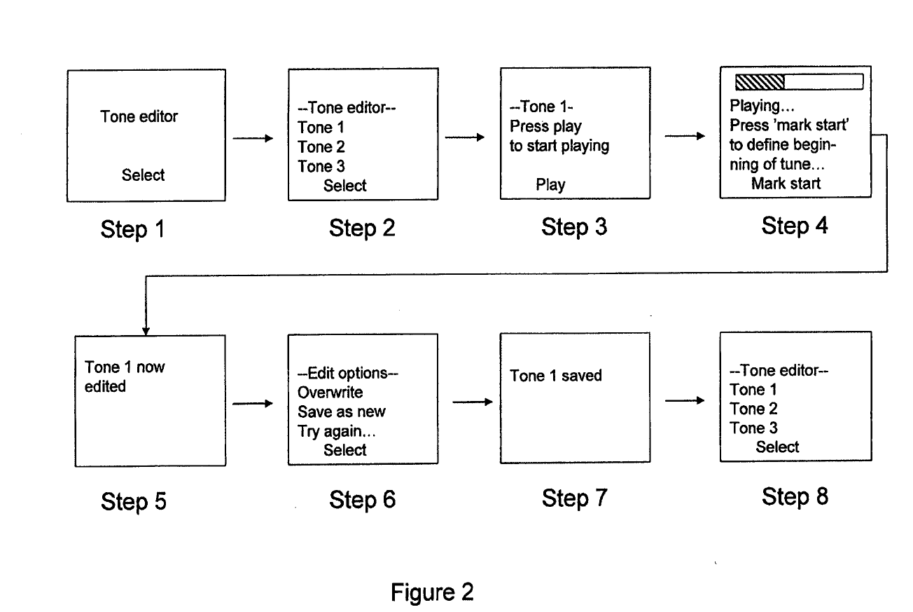

FIG. 2 is a flow diagram of the selecting procedure.

FIG. 1 illustrates a mobile telephone 10 having a standard keyboard 20, a microphone 30, a speaker 40, and navigation keys 50 for navigation in the menu structure of the telephone 10, as well as a display 60.

The telephone also comprises means for wireless communication 80 with an external provider 90 as is normal for conducting telephone conversations, receiving/sending SMS/MMS or the like.

In addition, the telephone 10 comprises a processor 100 for controlling the operation of the telephone.

The present invention relates to the receipt of an audio signal. This signal may be received from a CD player 92 (or radio, TV, DVD, CD-ROM, audio equipment, such as a synthesizer, PC, computer, memory device or the like) over a wire 93.

The CD player has a CD or other storage medium 94 (or a receiver for receiving information from another source as would be the case for e.g. a radio or a TV) and a speaker 96.

In one embodiment, the CD player 92 plays the CD 94 and transmits the sound signal (audio signal) to the telephone 10 over wire 93 while playing the signal over the speaker 96.

The user will then, using the below method, determine, using the telephone, which part of the received audio signal is to be used as e.g. a ringing tone of the telephone. This determination is based on the sound as provided to the user from the speaker 96.

Alternatively, the signal may be transferred to the telephone 10 and provided to the user via the speaker 40 of the telephone. In that manner, the full audio information may be transferred to the telephone 10 and the selection may then be made at any time subsequent to the transfer of the information to the terminal.

In order to store the full audio signal or at least the selected part thereof, the telephone 10 comprises storage 110, such as a RAM, EPROM, EEPROM, hard disc, optical disc, or the like.

Naturally, the audio information may be received or transferred using wireless communication, such as radio communication, IR communication, blue tooth, or the like. This communication may be with the external provider 90 or other equipment, such as the above-mentioned audio equipment, computers or the like.

It should be noted that the audio signal selected may be used for other purposes than ringing tones, such as for informing the user that a SMS/MMS or the like has been received, or that a certain calendar item (meeting or the like) is approaching.

The actual manner of selecting the audio to be used by the mobile telephone is described in FIG. 2 mainly as examples of the views on the display 60.

In step 1, the user enters the menu structure of the telephone by using the navigation keys 50. The tone editor is selected.

In step 2, the user is asked to determine which of the tones of the telephone is to be edited, and after selecting one, in step 3, the user instructs the telephone to play a pre-stored audio track to the user. In step 4, the user is asked to mark the start of the part of the audio track which is to be used as a later ringing tone or the like.

An alternative to step 3 is to have the audio track fed to the telephone 10 in real time, whereby this step may be avoided. The user then simply marks the start of the desired audio track in step 4 when that point in time arises.

The telephone 10 may automatically select a predetermined part (duration) of the audio track, or the user may be asked to mark both beginning and end of the desired part. This marking may be either the pushing of one or more of the keys (20 or 50) of the telephone or the constant depressing of a key while the desired part is played.

A bar is illustrated during step 4 in order for the user to see the progress of the pre-stored audio signal. Alternatively, the bar may be used for illustrating to the user how much more time may be used for the audio signal in the situation where only a predetermined maximum duration (time duration or maximum memory expenditure) is allowed.

The audio information will normally be an audio recording, such as a music recording. However, it may also be generated directly by a musical instrument or by the voice of one or more persons. The selected part may be a chorus of a song, part of a conversation, monologue, or any part of any audio track or the like.

In step 5, the user is informed that the tone is now edited and the user is, in step 6, asked how this new tone is to be stored (overwrite an existing tone, save it as a new one). Also, the user can choose to try a better definition of the desired part, if the former starting/ending times were not optimal.

In step 7, the new tone is saved, and the telephone then returns to the original screen of step 2. The user then may exit this part of the menu structure and proceed to the definition, In the telephone, of when to use the newly defined audio signal.

Thus, instead of a complicated manipulation of audio outside the telephone, the user may perform the selection quite easily using the telephone itself.

The audio signal provided to the telephone may have any of a wide variety of encodings or compression formats, such as MIDI, MP3, WAV, or TrueTones. It may be desired to be able to convert audio of these formats to a predetermined format in order to be better able to handle the audio in the telephone.

Also, conversion may be from packet-based form to another form in order to e.g. be better able to precisely define starting and ending times. The audio signal in packet-based audio may be provided in bits (one in each packet) or in portions consisting of several bits, such as in MP3 or MIDI format, which may be inconvenient if the starting/ending time is inside such a bit or portion of the audio information.

Also, more information may be present (the number of channels or tones in the signals) than is suitable for the telephone. The conversion may also act to reduce the amount of information in the signal (and even within the same encoding/compression).

Therefore, the processor 100 of the telephone may comprise a converter from a number of encodings/compressions/schemes to one or more predetermined forms/schemes of audio information.

It should be noted that even though the present invention has been described with reference to a mobile telephone, the same functionality may be provided in any other mobile terminal, such as a PDA, pocket calendar or the like.

1. A method of attracting the attention of a user of a mobile terminal, the method comprising:
the mobile terminal receiving audio information,
providing the audio information to the user,
the user operating, during the providing step, selecting means of the mobile terminal so as to select part of the audio information,
the mobile terminal subsequently attracting the attention of the user by playing the selected part of the audio information.

2. A method according to claim 1, wherein the selecting step comprises storing the selected part of the audio information in the mobile terminal.

3. A method according to claim 1, wherein the providing step is performed by a signal source transmitting the audio information to the mobile terminal.

4. A method according to claim 1, wherein the mobile terminal is a mobile telephone, and wherein the attracting step comprises the mobile telephone receiving an incoming telephone call.

5. A mobile terminal comprising:
means for receiving audio information,
means for allowing the user to select part of the audio information, while the receiving means receive the information,
means for attracting the attention of the user by playing the selected part of the audio information, and
means for determining that the attention of the user is desired/required, the determining means being adapted to operate the attracting means

6. A mobile terminal according to claim 5, further comprising means for providing the information to the user while receiving the information.

7. A mobile terminal according to claim 5, wherein the selecting means comprises a push button, a depression of which defines a starting point of the selected part of the audio information.

8. A mobile terminal according to claim 7, wherein the selecting means comprises a push button, a depression of which defines an ending point of the selected part of the audio information

9. A mobile terminal according to claim 5, wherein the mobile terminal is a mobile telephone and wherein the determining means are adapted to operate the attracting means when receiving an incoming telephone call.

10. A mobile terminal comprising:
means for receiving audio information,
means for providing the audio information to the user,
means operable by the user for selecting part of the audio information, while providing the information,
means for attracting the attention of the user by playing the selected part of the audio information, and
means for determining that the attention of the user is desired/required, the determining means being adapted to operate the attracting means.

11. A mobile terminal according to claim 10, wherein the selecting means comprises a push button, a depression of which defines a starting point of the selected part of the audio information.

12. A mobile terminal according to claim 11, wherein the selecting means comprises a push button, a depression of which defines an ending point of the selected part of the audio information.

13. A mobile terminal according to claim 10, wherein the mobile terminal is a mobile telephone and wherein the determining means are adapted to operate the attracting means when receiving an incoming telephone call.

14. A software system for performing the steps of claim 1 in a mobile terminal.
